(19) United States
(12) Patent Application Publication
(10) Pub. No.: US 2010/0017944 A1
(43) Pub. Date: Jan. 28, 2010

(54) PROCESS FOR THE PRODUCTION OF A GEMSTONE ARRANGEMENT

(76) Inventors: Martin HIRSCHMANN, Fritzens (AT); Harald LEITNER, Volders (AT)

Correspondence Address: WENDEROTH, LIND & PONACK, L.L.P., 1030 15th Street, N.W.,, Suite 400 East, Washington, DC, 20005-1503, US

(21) Appl. No.: 12/505,744

(22) Filed: Jul. 20, 2009

(30) Foreign Application Priority Data
Jul. 23, 2008 (AT) 1140/2008

(51) Int. Cl. A41D 27/08; A44C 17/02; B23P 5/00

(52) U.S. Cl. 2/244; 63/26; 29/10

(57) ABSTRACT

A process for the production of a gemstone arrangement comprising a plurality of gemstones which are held by a flexible carrier in receiving openings, and wherein the gemstones each have a setting surface and a visible surface and are so arranged in the desired arrangement or randomly distributed that the visible surfaces are on one side of a notional surface and the setting surfaces are on the other side of the notional surface, wherein a carrier material is applied in fluid form to the setting surfaces and between them and after hardening forms the flexible carrier.

The invention concerns a process for the production of a gemstone arrangement comprising a plurality of gemstones which are held by a flexible carrier in receiving openings, and wherein the gemstones each have a setting surface and a visible surface and are so arranged in the desired arrangement or randomly distributed that the visible surfaces are on one side of a notional surface and the setting surfaces are on the other side of the notional surface.

The state of the art already includes processes for the production of gemstone arrangements held by a thermoplastic film, wherein a melt adhesive layer has been applied to the film or to the setting surfaces of the gemstones, with which they are arranged in the film. Such a gemstone arrangement and the process used for the production thereof is shown for example in AT 338 020, wherein the thermoplastic film is placed on the gemstones and is then subjected to deep drawing and receiving openings are formed in the film, in which the gemstones are held by the film and by the adhesive. Disadvantages of that process are on the one hand its complexity as a large number of auxiliary means and process steps is required and on the other hand the fact that handling with the film and the melt adhesive is unwieldy. In addition it has been found in practice that, in the case of such gemstone arrangements, the gemstones however are held not particularly well by the film.

A further process for the production of gem elements is disclosed in DE 42 14 035. Here negative molds of moist clay are lined with stones and liquid hot melt adhesive is then cast therein. It has been found that this procedure suffers from the disadvantage that an unwieldy casting mold of moist clay is required and placement of the gemstones is either effected individually by hand and is therefore very burdensome or however it is effected in an uncontrolled fashion. Especially coated setting surfaces can be little taken into consideration in that fashion.

A process for embedding gemstones in plastic carriers by means of an injection molding process is described in FR 734 608. That process is also awkward and involved and requires many auxiliary means, in particularly the tools required for injection molding processes.

The object of the invention is to provide a process for the production of a gemstone arrangement, which avoids the above-mentioned disadvantages and facilitates the production procedure.

That object is attained by a process having the features of claim 1.

An arrangement of the gemstones where visible surfaces and setting surfaces of the gemstones are separated by a notional surface decisively facilitates implementation of the gemstones into a carrier. Application of the carrier material is made possible in a particularly advantageous fashion, by virtue of that surface separation. In that case the carrier is formed from a fluid hardenable material, wherein the carrier material is applied in fluid form to the side of the setting surface and hardens there. After hardening of the carrier the gemstones are already directly joined thereto and there is no need for an additional adhesive layer or the like. In addition such a join is highly stable. The carrier itself is thin and is bendable and flexible even after hardening. It can be particularly advantageous in that respect that the fluid carrier material is applied from above in the direction of the force of gravity to the setting surface of the gemstones.

The gemstones for the process according to the invention generally have setting surfaces with which they are arranged in the carrier and visible surfaces which are disposed on the side of the carrier, that is towards the viewer. In that respect the visible surfaces and additionally or alternatively the setting surfaces can be specifically designed for their purpose. For example the setting surfaces can be of a special geometrical shape, for example in the shape of a rotational cone, so that the carrier can particularly well hold the gemstones. The visible surfaces in turn can be for example ground in a facet configuration to enhance the visual attraction of the gemstone. It is also possible to provide special coatings for visible surfaces and setting surfaces.

Further advantageous configurations of the invention are defined in the appendant claims and are described in greater detail hereinafter.

In that respect in a preferred embodiment of the invention it is provided that the gemstones are arranged in regular rows and columns. In that case the gemstones can be arranged for example with a sieve device in such a way that they are disposed in regular rows and columns, and in that case the setting surfaces and the visible surfaces are so oriented that the visible surfaces and the setting surfaces of the gemstones respectively lie on one side of a notional surface. It can be particularly advantageous in that respect for the notional surface to be as smooth as possible, that is to say to represent for example portions of a plane or a cone surface, and in that respect to be oriented at least in the carrier material application zone, in such a way that the carrier material is applied from above in the direction of the force of gravity to the setting surfaces of the gemstones. By virtue of a grid raster-shaped arrangement, gemstones can be applied for example in the form of strips to an article such as to the surface of an article of clothing or a fashion accessory.

In a particularly preferred embodiment of the invention the gemstones project with their visible surfaces at least partially out of the flexible carrier. That provides that the gemstone arrangement acquires a particularly advantageous decorative appearance, in particular if the visible surfaces of the gemstones have facet grinding.

The carrier material is applied in a fluid condition in a thin layer to the setting surfaces of the gemstones and between them. In that respect in a preferred embodiment of the process according to the invention the fluid carrier material can be applied by spraying, sprinkling, wiping, brushing and additionally or alternatively rolling. All those processes which are known per se in the state of the art are distinguished by being easy to employ and by the low level of technical complication and expenditure required for that purpose. In particular no especially necessary casting molds of metal or ceramic materials, cavities or the like are needed for that purpose.

In a particularly preferred embodiment of the process according to the invention the gemstones are sieved in a desired pattern or also in a grid raster form, wherein the sieve is adapted to the size of the gemstones, and is then transferred into a deep drawing tool so that the gemstones lie with their setting surfaces in the deep drawing tool. If the setting surfaces have been provided with a reflection layer or with an interference-generating layer or with an absorbing layer, the gemstones are therefore disposed with the coated side downwardly in the deep drawing tool.

In a preferred embodiment of the invention it is provided that a thermoplastic deep drawing film is applied to the visible surfaces of the gemstones which are arranged in the deep drawing tool. By heating that deep drawing film is put into a thermoplastic condition whereby the film adopts the complete contour of the visible surfaces of the gemstones, that project out of the deep drawing tool.

In addition it may be advantageous for the deep drawing film to be subjected to deep drawing by means of reduced pressure, whereby adaptation of the deep drawing film to the contour of the visible surfaces of the gemstones is further improved. The deep drawing film together with the gemstones is then pulled off the deep drawing tool.

In an embodiment of the invention the pulled-off deep drawing film with the embedded gemstones is turned over so that the setting surfaces of the gemstones face upwardly. The carrier material can then be applied in fluid form to the setting surfaces and between them from above, that is to say in the direction of the force of gravity. The gemstones are thereby covered with fluid carrier material to the depth at which the deep drawing film is disposed. If therefore the gemstones are encased by the film as far as the girdle, the gemstones are embedded in the carrier with their setting surfaces as far as the girdle.

It may also be advantageous, after the carrier has hardened, to apply an adhesive film layer, a hot melt adhesive layer, a filling layer, a composite layer, an effect layer and additionally or alternatively a cover layer. Such layers are advantageous in particular when further optical effects are desired or they serve as an application device for the gemstone arrangement for example to an article of clothing. Protective layers for transport of the gemstone arrangement can also be advantageous.

The invention further concerns a gemstone arrangement having a plurality of gemstones which are arranged at least partially in a flexible carrier and are held thereby in receiving openings, in particular produced with a process as described hereinbefore, wherein the flexible carrier includes a reactive resin, preferably polyurethane resin and/or acrylate resin and/or epoxy resin.

Such a reactive resin which becomes fluid at a heat supply and then hardens has the properties that it is bendable and flexible after hardening, but it can nonetheless firmly hold the gemstones as its tensile strength is sufficiently high. That can involve polyurethane resin and additionally or alternatively acrylate resin and epoxy resin. A possible combination is represented for example by a copolymer of acrylate resin and urethane resin. When such a resin is applied in fluid form to the gemstones or the gemstones are immersed in such a fluid resin and that resin then hardens, then, by virtue of its chemical basis, it has the desired mechanical properties in respect of tensile strength and flexibility. In that respect it can be provided that other materials, preferably consisting of plastic material, are additionally used as the carrier material. It can however also be advantageous for the carrier to comprise one or more of the above-mentioned resins.

It can also be particularly advantageous for the flexible carrier to be produced from precisely one layer, comprising a reactive resin. That has the advantage that production of the carrier is particularly economical and the carrier can be particularly flexible.

The invention further concerns a gemstone arrangement having a plurality of gemstones which are arranged at least partially in a flexible carrier and are held thereby in receiving openings, in particular produced with a process as described hereinbefore, and a carrier comprising the above-described materials, wherein upon stretching of the flexible carrier along a straight line the flexible carrier is irreversibly deformed or tears before the flexible carrier loses the capacity to hold the gemstones by virtue of the deformations of the receiving openings, caused by the stretch.

If for example a tensile force is applied to such a gemstone arrangement, the receiving openings initially stretch within the limits of the linear range of elasticity in the direction of the tensile force whereby the adhesion forces of the film on the gemstones are reduced in that direction. At the same time however by virtue of the elasticity of the carrier material, the receiving openings contract in a direction perpendicularly to the tensile force, which causes a resulting force to be applied to the gemstones from the carrier. As a result, in addition to the above-mentioned lower level of adhesion, the stone is urged out of the receiving openings. It was found in that respect in accordance with the invention that a good join is afforded between gemstones and carrier if such deformations however remain slight as far as the irreversible deformation limit or the breaking limit.

One of the main areas of use of gemstone arrangements according to the invention involves decorating articles of clothing, fashion accessories or similar by the application of gemstones. Such decoration is particularly simple and easily possible by virtue of a gemstone arrangement according to the invention. As the articles to which a gemstone arrangement according to the invention is applied can have surfaces of any desired shape the gemstone arrangement must be itself flexible for adaptation to that surface. It will be appreciated in that respect that the gemstones should remain as durably as possible in the carrier, which is achieved by virtue of the deformation phenomena in respect of the receiving opening remaining low in the event of tensile loadings as generally occur at least locally when the gemstone arrangement is flexed, so that the adhesion forces are approximately as in the situation involving a non-loaded gemstone arrangement according to the invention or are at least sufficiently great to hold the gemstones in the carrier. It is only if the tensile loading becomes excessively great that the carrier is irreversibly deformed or tears away. Such loadings however do not occur in the usual use of a gemstone arrangement according to the invention so that such a situation can occur practically only when force is maliciously applied to the carrier.

It can be advantageous in that respect for stretching of the gemstone arrangement to be effected in accordance with the international standards applicable for tensile testing in relation to plastic materials (ISO 527-1 and ISO 527-2). The tensile strength established in that respect correlates with the deformation phenomena in the elasticity range and therefore provides information about the degree of such deformation phenomena. A high value in respect of tensile strength provides that the gemstones are held by the carrier up to the irreversible deformation limit or the breaking limit.

In a particularly preferred embodiment of the invention it is provided in that respect that the gemstones are at least partially cast into the carrier. That can be achieved by the gemstones being arranged in fluid carrier material or however by carrier material being applied in a fluid condition to the gemstones. The carrier material then hardens. In that respect gemstones which are cast in place have an extremely firm join to the carrier material, wherein the fact that the gemstones are at least partially cast in place means that parts of the gemstones can also remain free to impart the desired optical effect to the gemstone arrangement.

It can further be provided that the carrier material is so thin that the ends of the setting surfaces, with which the gemstones are arranged in the carrier, protrude above the remaining surface of the carrier at the side of the carrier, that is remote from the visible surfaces of the gemstones. In that case the carrier surface can be substantially flat at the side of the carrier, that is remote from the visible surface of the gemstones, and additionally or alternatively the ends of the setting surfaces of the gemstones can project above the carrier material or however the ends of the setting surfaces can also be encased by the carrier material so that the carrier material itself provides a relief-like surface at the side of the carrier, that is remote from the visible surfaces.

It can be provided in that respect that the arrangement of the gemstones is of a grid raster-like nature. The gemstones however can also be arranged in any pattern or also randomly on the carrier.

As a large number of gemstones are used in particular when the gemstones are arranged in a grid raster-like configuration, an inexpensive kind of gemstones is particularly desirable. For that purpose in a preferred embodiment of the invention the gemstones are glass stones. In that case particularly elegant gemstone arrangements are achieved if the glass stones themselves are ground, for example in the form of a faceted surface. In that respect it may suffice if the visible surfaces of the glass stones are ground. It will be appreciated that it is also possible to use chatons or precious stones for a gemstone arrangement according to the invention.

In a preferred configuration in that respect the thickness of the carrier, at least between the setting surfaces of the gemstones, is of a thickness of between 0.2 and 1.5 mm, preferably between 0.5 and 1 mm. In that respect however it can be provided that the thickness of the carrier is less on the ends of the setting surfaces or there is no carrier material at all on the ends of the setting surfaces.

In a preferred embodiment of the invention the gemstones used can have a reflection layer at their setting surfaces. It can however also be provided that the gemstones have non-mirrored setting surfaces. Particularly in the case of glass stones, it is then possible to achieve visually attractive combination effects as between the color of the carrier material and the refraction properties or the color of the gemstones. Furthermore it can be provided that the carrier itself at least partially comprises transparent material. That is particularly advantageous if the gemstone arrangement is to be arranged on an article of clothing or a fashion accessory whereby the color of the article of clothing or the fashion accessory is not covered by the material of the carrier. It can however also be provided that the carrier is colored whereby particularly when the rear side of the gemstones is non-mirrored the color of the carrier material shimmers through the gemstones.

It can further be provided that at least parts of the gemstones are coated with a bonding primer. Such a bonding primer, for example polyurethane-based or epoxy-based, can further improve the join between gemstones and carrier.

It can further be advantageous if the gemstones are embedded in the carrier substantially as far as the girdle. The result of this is that the simili layer is better protected.

Further decorative effects can be produced by the gemstones being at least partially provided with interference-generating layers or with absorbing layers, for example by vapor deposition of such a layer on the gemstones.

In a further embodiment of the invention it can be provided that a or also more further layers are arranged at the side of the carrier, that is remote from the visible surfaces. That can include for example an effect layer which can give the gemstone arrangement a preferred optical appearance, when viewing thereon. In particular metal films such as gold films, aluminum films or vapor-deposited polyester films with a metal effect or colored plastic films are considered for such an effect layer. In addition for example with a hot melt adhesive layer a filling layer can be applied, preferably comprising easily compressible material. In addition it may be advantageous once again to arrange a layer of adhesive film, preferably self-adhesive film, for example by means of a melt adhesive layer. Such a self-adhesive film has the advantage that the gemstone arrangement can be particularly easily mounted therewith to a desired article, with the gemstone arrangement adhering to the article by way of the self-adhesive film. For transport of the gemstone arrangement it can further be provided that a cover layer for example of paper or plastic material, preferably silicone-coated paper, protects the self-adhesive film.

Further details and advantages of the present invention are described in greater detail hereinafter by means of the specific description with reference to the drawings in which:

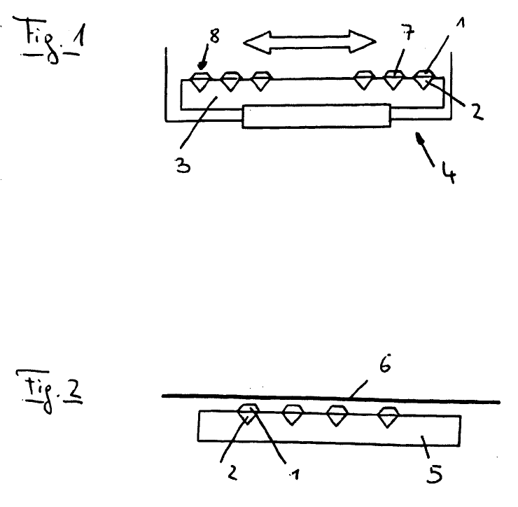

FIGS. 1-6 show various steps in an embodiment of the process according to the invention, and

FIG. 7 shows a cross-section through a gemstone arrangement according to the invention.

FIG. 1 shows a sieving application device 4 which serves for sieving the gemstones 8 on the carrier in the desired arrangement or motif form. In the illustrated diagrammatic section the gemstones 8 are arranged in rows and columns. In this case the gemstones 8 are arranged in the sieving plate 3 by a reciprocating movement of the sieving device 4, in such a way that the possibly coated setting surfaces 2 of the gemstones 8 are directed vertically downwardly into the sieving plate 3 which has receiving openings corresponding to the setting surfaces 2 of the gemstones 8 while the visible surfaces 1 of the gemstones 8 remain outside the sieving plate 3 and are directed upwardly. In this embodiment the upper plane of the sieving plate 3 coincides with the girdle 7 of the gemstones 8, which in this case separates the visible surfaces 1 and the setting surfaces 2 of the gemstones 8.

FIG. 2 diagrammatically shows how a thermoplastic deep drawing film 6 is arranged above the visible surfaces 1 of the gemstones 8 which are transferred into a deep drawing tool 5. In addition arranged beneath or in the deep drawing tool 5 are devices which with a vacuum pump and by way of suction connections arranged for that purpose in the deep drawing tool 5, suck air out of the space between the sieving plate 3 and the deep drawing film 6 and thereby produce a reduced pressure. For the sake of enhanced clarity such devices for producing a vacuum, which are known per se in the state of the art, have not been illustrated in the Figure. A heating device which can heat the deep drawing film 6 is also not shown. This can involve for example a heat radiating device arranged above the deep drawing film 6. It can also be provided that the film together with the deep drawing tool 5 is arranged in an oven.

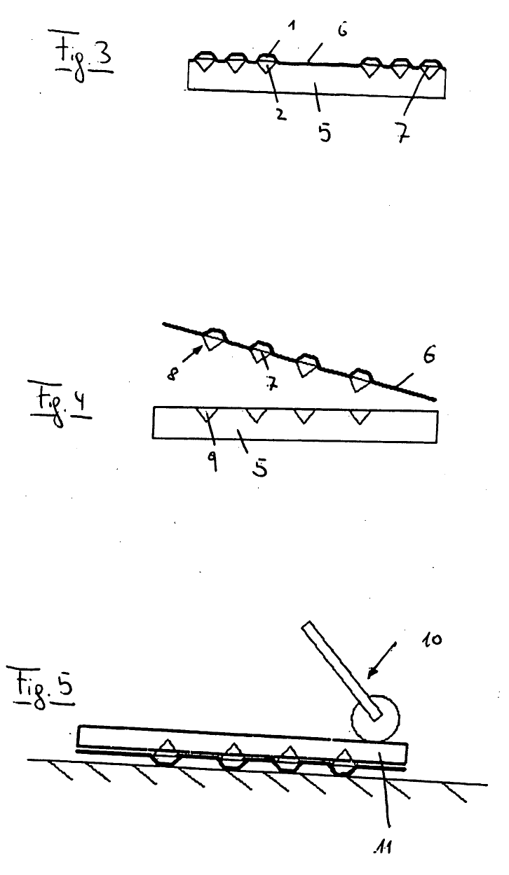

FIG. 3 shows how the deep drawing film 6 completely assumes the contour of the visible surfaces 1 of the gemstones 8, that project out of the deep drawing tool 5, after the deep drawing film 6 has been heated and thereby, as from a certain temperature dependent on the film material, has reached a thermoplastic state and at the same time has been deep drawn by means of the air sucked away by the deep drawing tool 5 and the reduced pressure resulting therefrom. When now the temperature is lowered again the deep drawing film 6 sets and thereby holds the gemstones 8 with their visible surfaces 1.

FIG. 4 shows how the gemstones 8 with the deep drawing film 6 are pulled away from the deep drawing tool 5. The recesses 9 provided for the gemstones 8 in the deep drawing tool 5 are also visible in this respect. By virtue of the deep drawing film 6 setting, the visible surfaces 1 of the gemstones 8 adhere in the deep drawing film 6.

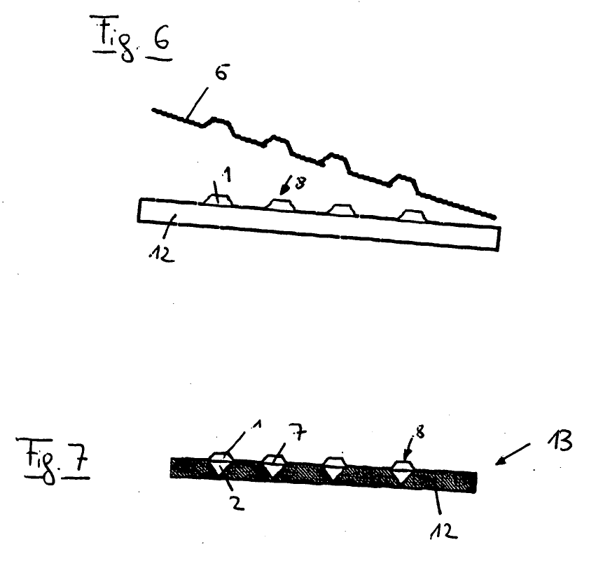

After the deep drawing film 6 with gemstones 8 adhering therein has been turned and therefore the visible surfaces 1 of the gemstones 8 face downwardly, the fluid carrier material 11 is applied by means of a rolling device 10 in a thin layer to the setting surfaces 2 and between them and rolled out, as diagrammatically shown in FIG. 5.

Thereupon the carrier material can harden so that the gemstones 8 are durably held in the flexible carrier 12. Therefore, as shown in FIG. 6, the deep drawing film 6 can be pulled off again. The gemstones 8 are embedded in the flexible carrier 12 of the gemstone arrangement 13 according to the invention in such a way that only the visible surfaces 1 thereof are protruding.

FIG. 7 shows a cross-section through a gemstone arrangement 13 according to the invention. In this case the thin flexible carrier 12 is of such a thickness that the tips of the setting surfaces 2 of the gemstones 8 project at the lower end of the carrier 12. The gemstones 8 are embedded in the carrier 12 as far as their girdle 7, separating the visible surfaces 1 from the setting surfaces 2 of the gemstones 8.

It will be appreciated that the gemstone arrangement according to the invention is not restricted to the embodiments illustrated in the Figures and set forth in the description, nor is it to be limited thereby.

In this respect the invention can have both only one kind of gemstones in respect of shape and/or material, and also a multiplicity of different kinds of gemstones, and can therefore be of a homogeneous or heterogeneous nature. In addition not all gemstones have to be equally embedded in the carrier, although that is preferred.

1. A process for the production of a gemstone arrangement comprising a plurality of gemstones which are held by a flexible carrier in receiving openings, and wherein the gemstones each have a setting surface and a visible surface and are so arranged in the desired arrangement or randomly distributed that the visible surfaces are on one side of a notional surface and the setting surfaces are on the other side of the notional surface, wherein a carrier material is applied in fluid form to the setting surfaces and between them and after hardening forms the flexible carrier.

2. A process as set forth in claim 1 wherein the gemstones are arranged in the flexible carrier in regular rows and columns.

3. A process as set forth in claim 1 wherein the carrier material is applied in such a way that the visible surfaces project at least partially out of the hardened flexible carrier.

4. A process as set forth in claim 1 wherein the carrier material is applied in fluid form to the setting surfaces of the gemstones and between them, by at least one way selected from the group consisting of spraying, sprinkling, wiping, brushing and rolling.

5. A process as set forth in claim 1 wherein the gemstones are sieved on and are then transferred into a deep drawing tool, the gemstones lying with their setting surfaces in the deep drawing tool.

6. A process as set forth in claim 5 wherein a deep drawing film is applied to the visible surfaces of the gemstones.

7. A process as set forth in claim 6 wherein the deep drawing film is deep drawn by means of reduced pressure and then pulled off the deep drawing tool together with the gemstones.

8. A process as set forth in claim 7 wherein said deep drawing film is heated when said deep drawing film is deep drawn by means of reduced pressure.

9. A process as set forth in claim 8 wherein the deep drawing film is pulled off the carrier after hardening of the carrier material.

10. A process as set forth in claim 1 wherein at least one of the layers selected from the group consisting of an adhesive film layer, a melt adhesive layer, a filling layer, a composite layer, a effect layer and a cover layer is applied to the carrier.

11. A gemstone arrangement comprising a plurality of gemstones which are arranged at least partially in a flexible carrier and are held thereby in receiving openings, wherein the flexible carrier includes a reactive resin.

12. A gemstone arrangement as set forth in claim 11 wherein said reactive resin comprises at least one resin selected from the group consisting of a polyurethane resin, an acrylate resin and an epoxy resin.

13. A gemstone arrangement comprising a plurality of gemstones which are arranged at least partially in a flexible carrier and are held thereby in receiving openings wherein said flexible carrier includes a reactive resin and wherein said gemstone arrangement is produced by a process as set forth in claim 1.

14. A gemstone arrangement as set forth in claim 13 wherein said reactive resin comprises at least one resin selected from the group consisting of a polyurethane resin, an acrylate resin and an epoxy resin.

15. A gemstone arrangement as set forth in claim 11 wherein the flexible carrier consists of a reactive resin.

16. A gemstone arrangement as set forth in claim 15 wherein the reactive resin comprises at least one resin selected from the group consisting of a polyurethane resin, an acrylate resin and an epoxy resin.

17. A gemstone arrangement as set forth in claim 15 wherein the flexible carrier consists of precisely one layer of a reactive resin.

18. A gemstone arrangement as set forth in claim 17 wherein said reactive resin is a polyurethane resin or an acrylate resin or an epoxy resin.

19. A gemstone arrangement comprising a plurality of gemstones which are arranged at least partially in a flexible carrier and are held thereby in receiving openings, wherein upon stretching of the flexible carrier along a straight line the flexible carrier is irreversibly deformed or tears before the flexible carrier loses the capacity for holding the gemstones by virtue of the deformation of the receiving openings, that is caused by the stretching.

20. A gemstone arrangement comprising a plurality of gemstones which are arranged at least partially in a flexible carrier and are held thereby in receiving openings, as set forth in claim 11, wherein upon stretching of the flexible carrier along a straight line the flexible carrier is irreversibly deformed or tears before the flexible carrier loses the capacity for holding the gemstones by virtue of the deformation of the receiving openings, that is caused by the stretching.

21. A gemstone arrangement comprising a plurality of gemstones which are arranged at least partially in a flexible carrier and are held thereby in receiving openings, as set forth in claim 12, wherein upon stretching of the flexible carrier along a straight line the flexible carrier is irreversibly deformed or tears before the flexible carrier loses the capacity for holding the gemstones by virtue of the deformation of the receiving openings, that is caused by the stretching.

22. A gemstone arrangement as set forth in claim 11 wherein the thickness of the flexible carrier, at least between the setting surfaces of the gemstones, is between 0.2 mm and 1.5 mm.

23. A gemstone arrangement as set forth in claim 11 wherein the thickness of the flexible carrier, at least between the setting surfaces of the gemstones, is between 0.5 mm and 1.0 mm.

24. A gemstone arrangement as set forth in claim 11 wherein the gemstones are at least partially cast into the flexible carrier.

25. A gemstone arrangement as set forth in claim 11 wherein the ends of the setting surfaces of the gemstones project relief-like beyond the rest of the carrier surface at the side of the flexible carrier, that is remote from the visible surfaces.

26. A gemstone arrangement as set forth in claim 25 wherein the ends of the setting surfaces of the gemstones are encased by the flexible carrier.

27. A gemstone arrangement as set forth in claim 11 wherein the visible surfaces of the gemstones at least partially protrude beyond the surface of the flexible carrier.

28. A gemstone arrangement as set forth in claim 11 wherein the gemstones are arranged in grid raster form.

29. A gemstone arrangement as set forth in claim 11 wherein the gemstones are glass stones.

30. A gemstone arrangement as set forth in claim 29, wherein said glass stones are ground.

31. A gemstone arrangement as set forth in claim 11 wherein the gemstones are embedded in the flexible carrier substantially to the girdle.

32. A gemstone arrangement as set forth in claim 11 wherein the gemstones have a reflection layer at least at their setting surfaces.

33. A gemstone arrangement as set forth in claim 11 wherein at least parts of the setting surfaces of the gemstones are coated with a bonding primer.

34. A gemstone arrangement as set forth in claim 11 wherein the gemstones are provided with interference-generating layers or absorbing layers.

35. A gemstone arrangement as set forth in claim 11 wherein the flexible carrier comprises transparent material.

36. A gemstone arrangement as set forth in claim 11 wherein at least one of the layers selected from the group consisting of an adhesive film layer, a hot melt adhesive layer, a filling layer, a cover layer and an effect layer is applied at the side of the flexible carrier, that is remote from the visible surfaces.

37. An article of clothing with a gemstone arrangement as set forth in claim 11.

38. A fashion accessory with a gemstone arrangement as set forth in claim 11.
